(19) United States
(12) Patent Application Publication
(10) Pub. No.: US 2026/0020083 A1
(43) Pub. Date: Jan. 15, 2026

(54) ACCESS POINT WITH AUXILIARY ANTENNA PROVISION

(71) Applicant: Cisco Technology, Inc., San Jose, CA (US)

(72) Inventors: Fred Anderson, Port Charlotte, FL (US); John Matthew Swartz, Lithia, FL (US); Joshua Suhr, Lenexa, KS (US); Timothy Frank, Medina, OH (US); Nicholas Swiatecki, San Jose, CA (US)

(21) Appl. No.: 19/196,714

(22) Filed: May 1, 2025

Related U.S. Application Data
(60) Provisional application No. 63/669,642, filed on Jul. 10, 2024.

(51) Int. Cl. H04W 76/10; H04W 88/08

(52) U.S. Cl. CPC H04W 76/10; H04W 88/08

(57) ABSTRACT

Communication systems, devices, and methods for provisioning one or more auxiliary antennas are provided. A communication system includes a network device and a set of external antennas. The network device includes a set of integral antennas and one or more auxiliary connectors. The integral antennas generate at least one beam pattern defining a first coverage area corresponding, for example, to an area in front of the network device. The external antennas are couplable to the auxiliary connectors to generate one or more beam patterns defining a second coverage area disparate from the first coverage area. The second coverage area corresponds to an area below or behind the network device. A control logic detects and provisions the coupled external antennas based on one or more user inputs or a self-identifying antenna functionality, and by selectively re-routing a radio frequency signal path from the integral antennas to the auxiliary connectors.

### CROSS-REFERENCE TO RELATED APPLICATIONS

This application claims the benefit of priority to U.S. Provisional Application No. 63/669,642, filed Jul. 10, 2024, the entirety of which is incorporated herein by reference.

### FIELD

The present disclosure relates to wireless communication. More particularly, the present disclosure relates to an access point with auxiliary antenna provision.

### BACKGROUND

In large public venues (LPVs), for example, stadiums, arenas, or convention centers, access points (APs) are deployed for delivering seamless wireless connectivity to large crowds. However, the architectural challenges of these spaces often make it difficult to achieve comprehensive coverage with traditional AP setups. One particular challenge arises when an AP is mounted in elevated positions, such as on rafters or tiers, to cover areas that are farther ahead, such as large seating sections or a playing field. In these cases, the AP's integrated antennas are typically aimed forward, limiting coverage to areas directly in their line of sight. Unfortunately, such a setup can leave seating or spaces behind and/or underneath the AP with weak or insufficient signal strength.

This challenge becomes more pronounced in tiered stadium seating, where people seated beneath or behind an AP mounting point may experience degraded performance. In response, traditional solutions often call for either deploying a two-radio AP, where one radio serves forward-facing antennas while the other serves rearward-facing or downward antennas, or installing two entirely separate APs. While these approaches provide the necessary coverage, they introduce additional complexity, requiring increased Power over Ethernet (POE) cable runs, and more intricate installation processes. The result is a higher cost of deployment, maintenance, and troubleshooting due to the added layers of hardware and cabling infrastructure.

Newer AP architectures, however, have begun to address these challenges with more advanced designs that integrate multiple radios within a single device. These multi-radio APs have greater intrinsic capacity, allowing for improved management of available bandwidth and the possibility of provisioning additional coverage zones. Unfortunately, many of these APs still come with fixed integrated antennas that lack the flexibility needed for optimal signal targeting. Without the ability to aim individual antennas precisely, coverage gaps may persist, especially in areas directly beneath or behind the AP's mounting point.

### SUMMARY OF THE DISCLOSURE

Communication systems, devices, and methods for provisioning one or more auxiliary antennas in accordance with embodiments of the disclosure are described herein. In some embodiments, a network device includes a set of integral antennas configured to generate at least one beam pattern defining a first coverage area from a first end of the network device, and one or more auxiliary connectors extending from a second end of the network device, wherein the one or more auxiliary connectors are couplable to a set of external antennas to generate one or more beam patterns defining a second coverage area disparate from the first coverage area.

In some embodiments, the set of integral antennas includes beam-managed, front-facing antennas configured to receive and transmit radio frequency communication signals from the first end of the network device.

In some embodiments, the set of external antennas includes rear-facing antennas configured to receive and transmit radio frequency communication signals from the second end of the network device.

In some embodiments, a control logic is configured to detect and provision the set of external antennas coupled to the one or more auxiliary connectors.

In some embodiments, provisioning the set of external antennas includes configuring the set of external antennas based on one or more inputs received via a user interface.

In some embodiments, provisioning the set of external antennas includes automatically configuring the set of external antennas based on a self-identifying antenna functionality.

In some embodiments, provisioning the set of external antennas includes selectively re-routing a radio frequency signal path from the set of integral antennas to the one or more auxiliary connectors.

In some embodiments, the radio frequency signal path is selectively re-routed based on a self-identifying antenna discovery process.

In some embodiments, the control logic is further configured to perform radio frequency power management of the set of external antennas based on antenna gain characteristics.

In some embodiments, the first coverage area corresponds to an area in front of the network device.

In some embodiments, the second coverage area corresponds to at least one of an area below the network device or an area behind the network device.

In some embodiments, an auxiliary connector of the one or more auxiliary connectors allows at least one external antenna of the set of external antennas to be rotatably coupled thereto.

In some embodiments, an auxiliary connector of the one or more auxiliary connectors allows at least one external antenna of the set of external antennas to be rotatably coupled thereto via a mating connector.

In some embodiments, a communication system includes a network device including a set of integral antennas configured to generate at least one beam pattern defining a first coverage area from a first end of the network device, and one or more auxiliary connectors extending from a second end of the network device, and a set of external antennas couplable to the one or more auxiliary connectors to generate one or more beam patterns defining a second coverage area disparate from the first coverage area.

In some embodiments, at least one external antenna of the set of external antennas is rotatably couplable to an auxiliary connector of the one or more auxiliary connectors via a mating connector.

In some embodiments, at least one external antenna is tiltable via a hinged connection to the mating connector.

In some embodiments, at least one external antenna of the set of external antennas is couplable to an auxiliary connector of the one or more auxiliary connectors via a coaxial interconnect element.

In some embodiments, at least one external antenna of the set of external antennas is a direct-mount antenna.

In some embodiments, the first coverage area corresponds to an area in front of the network device and the second coverage area corresponds to at least one of an area below the network device or an area behind the network device.

In some embodiments, a method includes configuring a set of integral antennas to generate at least one beam pattern defining a first coverage area from a first end of a network device, detecting a coupling of an external antenna to an auxiliary connector of one or more auxiliary connectors extending from a second end of the network device, and selectively re-routing a radio frequency signal path from the set of integral antennas to the external antenna via the auxiliary connector to generate one or more beam patterns defining a second coverage area disparate from the first coverage area.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram of a wireless network environment in accordance with various embodiments of the disclosure;

FIG. 2 is a perspective view of a network device with an auxiliary antenna provision in accordance with various embodiments of the disclosure;

FIG. 3 is a block diagram of an architecture of a network device with an auxiliary antenna provision in accordance with various embodiments of the disclosure;

FIG. 4 is a schematic diagram showing different configurations of antennas for generating one or more beam patterns in accordance with various embodiments of the disclosure;

FIG. 5 is a perspective view of a communication system including a network device with an auxiliary antenna provision in accordance with various embodiments of the disclosure;

FIG. 6 is a flowchart depicting a process for provisioning an external antenna coupled to an auxiliary connector of a network device in accordance with various embodiments of the disclosure;

FIG. 7 is a flowchart depicting a process for detecting and provisioning an external antenna coupled to an auxiliary connector of a network device based on one or more user inputs in accordance with various embodiments of the disclosure;

FIG. 8 is a flowchart depicting a process for detecting and automatically provisioning an external antenna coupled to an auxiliary connector of a network device based on a self-identifying antenna functionality in accordance with various embodiments of the disclosure;

FIG. 9 is a flowchart depicting a process for detecting and automatically managing an external antenna coupled to an auxiliary connector of a network device in accordance with various embodiments of the disclosure; and

FIG. 10 is a conceptual block diagram for a device capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, communication systems, devices, and methods are discussed herein for provisioning one or more auxiliary antennas to flexibly aim multiple coverage areas for wireless communication requirements in challenging wireless environments such as Large Public Venues (LPVs). Coverage area may refer to a geographic region where a wireless communication signal may be reliably received by client devices, for example, smartphones, tablet computing devices, laptops, cellular phones, etc. In many embodiments, the communication systems, devices, and methods discussed herein may implement a network device, herein referred to as an “access point”, having integral antennas along with an auxiliary antenna provision.

LPVs, for example, stadiums, arenas, convention centers, airports, or the like often have extensive areas that need coverage to meet wireless communication requirements associated with high user or device density. LPV antenna systems may be used for high-density applications that benefit from multiple beam pattern coverage areas and long-range performance. High-density may refer to areas that need to support multiple client devices simultaneously. In LPVs, built-in or integral antennas in access points may have challenges with range or flexibility needed for optimal connections. Auxiliary antennas, herein referred to as “external antennas”, can extend the reach of a wireless network, ensuring signal availability throughout an LPV. Moreover, external antennas can help manage the increased demand for bandwidth and connectivity by providing better signal distribution. By positioning external antennas strategically, dead spots are minimized and overall signal strength is improved, leading to better user experiences for attendees at LPVs. Dead spots may refer to areas within a wireless network where the wireless communication signal is weak or completely absent, leading to poor or no connectivity for client devices.

Conventional multi-radio access points may offer coaxial ports for connecting separate external antennas. Other conventional access points may be configured to point antennas in different directions. However, access points with integral antennas may not provide auxiliary connectors for coupling external antennas thereto. External antennas, for example, wide patch antennas, narrow high-gain antennas, etc., are conventionally implemented in non-integrated solutions where they are aimed separately to cover disparate areas. Further, to prevent too much of a communication signal from overshooting the nearest part of an intended coverage area, a technique referred to as “null-fill” may be utilized in antenna systems. The null-fill technique in conventional antenna systems may be utilized to enhance signal coverage and reduce dead spots in specific areas. The null-fill technique may involve strategically placing antennas or adjusting their beam patterns to fill in areas where the communication signal may be weak or nonexistent (nulls). By altering the beam pattern of antennas, communication signals may be directed into areas that typically experience poor reception, effectively “filling” the nulls. However, these non-integrated and null-fill solutions may be inadequate for LPV applications as they may either dilute effectivity or may not be adaptable to all low angle or backfill situations, where beam pattern coverage may be required.

In a number of embodiments, the communication systems, devices, and methods discussed herein provide a network device, including integral antennas, integrated with a backfill antenna feature for creating multiple disparate coverage areas in challenging wireless environments such as, for example, LPVs. The network device may include a set of integral antennas configured to generate at least one beam pattern defining a first coverage area from a first end, for example, a front end, of the network device. In a variety of embodiments, the set of integral antennas may include beam-managed, front-facing or forward-facing antennas configured to receive and transmit Radio Frequency (RF) communication signals from the first end of the network device. In various embodiments, the first coverage area may correspond to an area in front of the network device. The network device may further include one or more auxiliary connectors extending from a second end, for example, a rear end, of the network device. In an example implementation, in addition to the integral front-facing antennas, the network device may include a set of rear-facing auxiliary antenna connectors, which provide flexibility to connect any legacy-cabled antenna and/or direct mount antennas thereto. The auxiliary connector(s) may be couplable to a set of external antennas to generate one or more beam patterns defining a second coverage area disparate from the first coverage area.

In more embodiments, at least one of the auxiliary connectors allows at least one external antenna to be rotatably coupled thereto via a mating connector. In additional embodiments, the at least one external antenna may be tiltable via a hinged connection to the mating connector. In further embodiments, the set of external antennas may include rear-facing antennas configured to receive and transmit RF communication signals from the second end of the network device. In still more embodiments, the second coverage area may correspond to at least one of an area below the network device or an area behind the network device.

In still further embodiments, the network device disclosed herein may offer flexibility in backfill coverage direction and pattern, with both a custom adjustable direct-attach antenna solution and ability to connect any other remote antenna to the network device via coaxial interconnect elements. In still additional embodiments, the network device may include a control logic configured to detect and provision the set of external antennas coupled to the auxiliary connector(s). In some more embodiments, the network device may perform entirely automatic detection and provisioning of any authorized external antenna that may be attached thereto. In yet various embodiments, the network device may configure the set of external antennas based on one or more inputs received via a user interface. For example, the coupled set of external antennas may be manually configured by a user via the user interface. In yet more embodiments, the network device may automatically configure the set of external antennas based on a self-identifying antenna functionality. In still yet more embodiments, the configuration of the set of external antennas may include RF power management of the set of external antennas based on antenna gain characteristics. In many further embodiments, the network device may selectively re-route an RF signal path from the set of integral antennas to the auxiliary connector(s). For example, the network device may selectively re-route a 2.4 gigahertz (GHz) and a 5 GHz signal path from the set of integral antennas to the auxiliary connectors to allow the set of external antennas coupled to the auxiliary connectors to generate the one or more beam patterns defining the second coverage area. In many additional embodiments, the network device may selectively re-route the RF signal path from the set of integral antennas to the auxiliary connector(s) automatically based on a self-identifying antenna discovery process. In still yet further embodiments, the network device disclosed herein with its backfill antenna feature may be utilized in challenging wireless environments, where a coverage area may be needed below and/or behind a principal front-facing coverage zone of the network device.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. Nevertheless, the executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in still yet additional embodiments, may alternatively be embodied by or implemented as a component.

A circuit, as used herein, comprises a set of one or more electrical and/or electronic components providing one or more pathways for electric current. In several embodiments, a circuit may include a return pathway for electric current, so that the circuit is a closed loop. In several more embodiments, however, a set of components that does not include a return pathway for electric current may be referred to as a circuit (e.g., an open loop). For example, an integrated circuit may be referred to as a circuit regardless of whether the integrated circuit is coupled to ground (as a return pathway for electric current) or not. In numerous embodiments, a circuit may include a portion of an integrated circuit, an integrated circuit, a set of integrated circuits, a set of non-integrated electrical and/or electrical components with or without integrated circuit devices, or the like. In numerous additional embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a PCB or the like. Each of the functions and/or modules described herein, in further additional embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

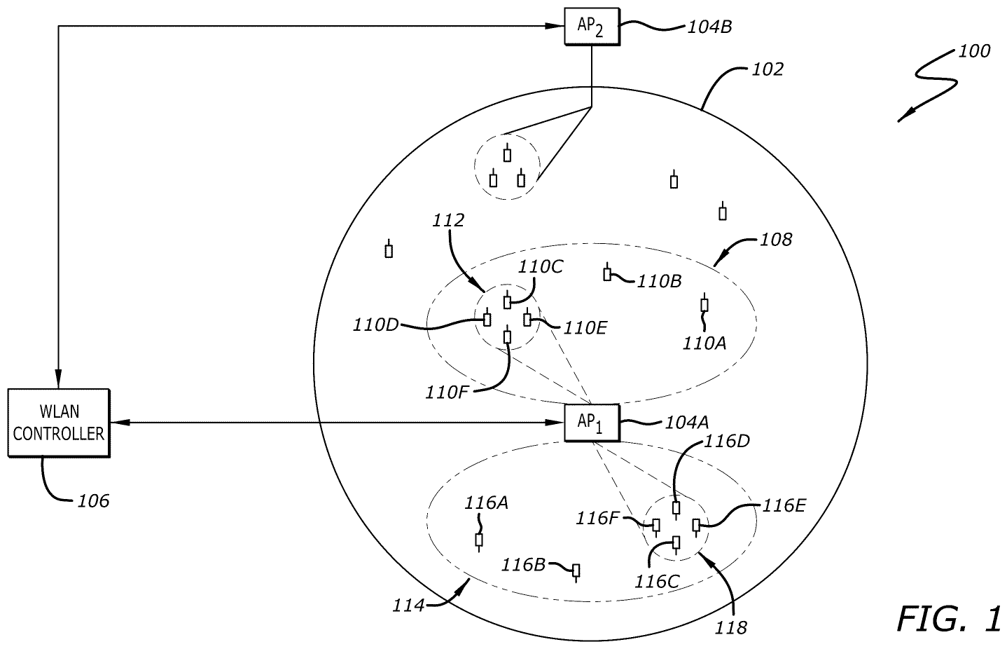

Referring to FIG. 1, a schematic diagram of a wireless network environment 100 in accordance with various embodiments of the disclosure is shown. In many embodiments, the wireless network environment 100 may include a Large Public Venue (LPV) 102 in which one or more client devices may be present. The LPV 102 may be, for example, a tiered stadium, an arena, a convention center, a stage, a park, etc. The client devices may be associated with users seated at the LPV 102 or users roaming within the LPV 102. The users seated at the LPV 102 may be referred to as “seated users”, and the users roaming within the LPV 102 may be referred to as “roaming users”. In an example, client devices 116A, 116B, 116C, 116D, 116E, and 116F shown in FIG. 1 may be associated with the seated users. The client devices 116A, 116B, 116C, 116D, 116E, and 116F may be collectively referred to as “client devices 116A-116F”. In a further example, client devices 110A, 110B, 110C, 110D, 110E, and 110F shown in FIG. 1 may be associated with the roaming users. The client devices 110A, 110B, 110C, 110D, 110E, and 110F may be collectively referred to as “client devices 110A-110F”. Examples of the client devices 110A-110F and 116A-116F may include smartphones, laptops, tablets, mobile devices, dual-mode cellular phones, wireless Voice-over-Internet Protocol (VOIP) phones, personal digital assistants (e.g., converged devices that support WLAN data and/or voice, and cellular), Internet-of-Things (IoT) devices, cellular base stations, gaming consoles, wearable devices, or the like. While several client devices 110A-110F and 116A-116F are shown in FIG. 1, more or fewer client devices may be utilized in conjunction with the LPV 102.

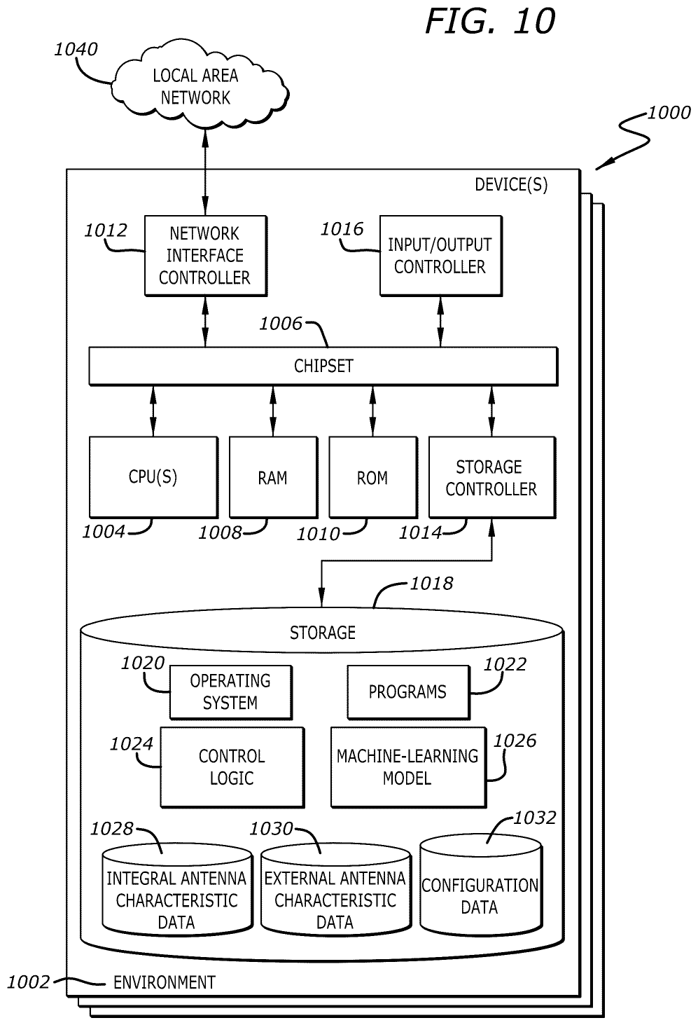

The LPV 102 may include one or more network devices (for example, access points such as an access point AP1 104A and an access point AP2 104B shown in FIG. 1) that may establish a Wireless Local Area Network (WLAN) to provide wireless network connectivity to wireless-capable devices such as the client devices 110A-110F and 116A-116F. The access points AP1 104A and AP2 104B, for example, wireless routers, may allow the client devices 110A-110F and 116A-116F, to connect to a wired network. The wired network may be a wired local area network, for example, the Ethernet. The access points AP1 104A and AP2 104B may act as bridges between the WLAN and the wired network. The WLAN may allow the client devices 110A-110F and 116A-116F to communicate with each other and connect to a network, for example, the Internet, wirelessly, within the LPV 102. The WLAN may utilize radio waves to transmit data between the client devices 110A-110F and 116A-116F. In a number of embodiments, the client devices 110A-110F and 116A-116F in the WLAN may be configured to operate in accordance with the IEEE 802.11 wireless communication technology, for example, Wi-Fi® of the Wi-Fi Alliance Corporation. In an example, the client devices 110A-110F and 116A-116F may connect to the access points AP1 104A and AP2 104B, respectively, to gain access to the WLAN. The access points AP1 104A and AP2 104B can communicate with each other to conduct operations in concert. In a variety of embodiments, the access points AP1 104A and AP2 104B may broadcast a Service Set Identifier (SSID) of the WLAN and handle data traffic between the client devices 110A-110F and 116A-116F and the network infrastructure. Each of the access points AP1 104A and AP2 104B may include a computing system as described in conjunction with FIG. 10.

In various embodiments, the WLAN may further include one or more wireless controllers such as a WLAN controller 106 as illustrated in FIG. 1. The embodiments shown in FIG. 1 may illustrate two access points AP1 104A and AP2 104B operably coupled to the WLAN controller 106 in the wireless network environment 100. In more embodiments, the WLAN controller 106 may be a computing device configured to manage and control actions of the access points AP1 104A and AP2 104B in the WLAN. Site-specific policies may be provisioned on the WLAN controller 106 to allow the access points AP1 104A and AP2 104B to join the wireless network environment 100 and to allow the WLAN controller 106 to control the wireless network environment 100. Although the WLAN controller 106 is shown as a single computing device in FIG. 1, the WLAN controller 106 may represent multiple different computing devices either physically located near the access points AP1 104A and AP2 104B, or physically separate and accessed through one or more networks, for example, the Internet or a cloud. In additional embodiments, the WLAN controller 106 may include a control logic configured to monitor or control power consumption of the access points AP1 104A and AP2 104B.

The communication systems, devices, and methods discussed herein may configure a wireless network for the LPV 102 in a manner that provides a simplified, quality user experience for users at the LPV 102. In further embodiments, the access points AP1 104A and/or AP2 104B may be configured to provide different Radio Frequency (RF) coverage areas, for example, coverage areas 108 and 114, depending on seating or other arrangements at the LPV 102. In still more embodiments, by way of a non-limiting example, the access point AP1 104A may be implemented with a backfill antenna feature in addition to a set of integral antennas to provide an additional coverage area 114, below and/or behind a principal front-facing coverage area 108 of the access point AP1 104A. The access point AP1 104A may be provisioned with one or more auxiliary antennas, herein referred to as “external antennas”, to flexibly aim multiple coverage areas for wireless communication requirements in the LPV 102. The access point AP1 104A with its integral antennas and provisions for one or more external antennas may provide local coverage in front of, below, and/or behind a mounting location of the access point AP1 104A. In still further embodiments, the access point AP1 104A with its integral antennas and provisions for the one or more external antennas may have intrinsic availability and capacity for provisioning additional coverage areas 108 and 114, without the need for increasing the number of individual radios within the access point AP1 104A. The access point AP1 104A may, therefore, offer the flexibility required in aiming multiple coverage areas 108 and 114 to meet the requirements of the LPV 102. In still additional embodiments, the WLAN controller 106 may configure the set of integral antennas and the external antennas coupled to the access point AP1 104A to a determined antenna vector or parameters to create targeted coverage areas that serve client device clusters 112 and 118, respectively, in the LPV 102.

In some more embodiments, the elements described above of the wireless network environment 100, for example, the WLAN controller 106, the access points AP1 104A and AP2 104B, etc., may be practiced in hardware, in software (including firmware, resident software, micro-code, etc.), in a combination of hardware and software, or in any other circuits or systems. In yet various embodiments, the elements of the wireless network environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of wireless network environment 100 may also be practiced using other technologies capable of performing logical operations such as, for example, AND, OR, and NOT, including but not limited to, mechanical, optical, fluidic, and quantum technologies. As described in greater detail below with respect to FIG. 10, the elements of the wireless network environment 100 may be practiced in a computing device 1000.

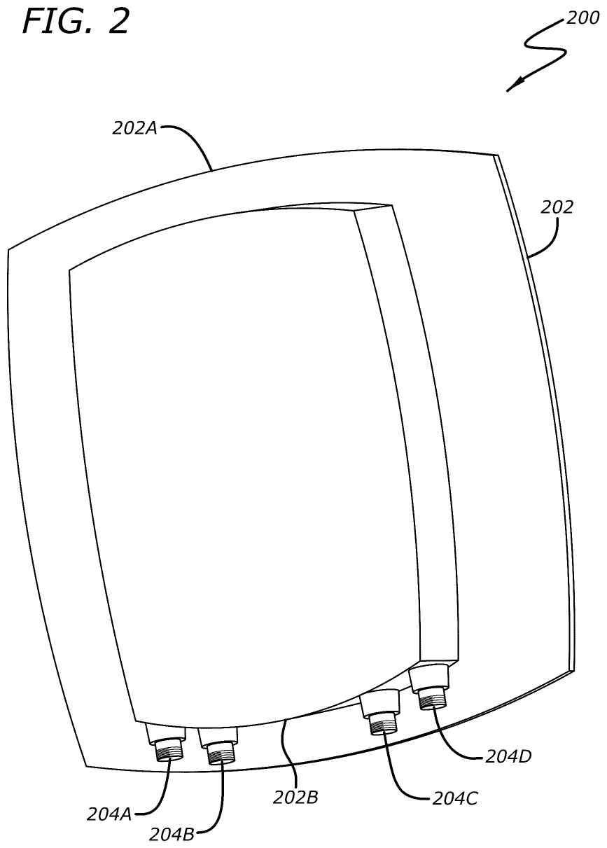

Although a specific embodiment for a wireless network environment 100 suitable for carrying out the various steps, processes, methods, and operations described herein is discussed with respect to FIG. 1, any of a variety of systems and/or processes may be utilized in accordance with embodiments of the disclosure. For example, although FIG. 1 may illustrate the LPV 102 including two access points AP1 104A and AP2 104B, the LPV 102 may be extended to include any number of access points and multiple levels of access points at several locations and elevations therewithin to provide local coverage areas 108 and 114 in front of, below, and/or behind mounting locations of the access points. Further, the implementation of the wireless network environment 100 is not limited to the LPV 102. In various embodiments, the wireless network environment 100 can be implemented in any area that requires disparate coverage areas for seamless wireless connectivity. The elements depicted in FIG. 1 may also be interchangeable with other elements of FIGS. 2-10 as required to realize a particularly desired embodiment.

Referring to FIG. 2, a perspective view of a network device with an auxiliary antenna provision in accordance with various embodiments of the disclosure is shown. In many embodiments, the network device may be an access point 200. As used herein, “access point” may refer to a Wi-Fi® access point (WAP), a femtocell, a hotspot, a picocell, or the like. The access point 200 may include a housing 202 with a front end 202A and a rear end 202B as illustrated in FIG. 2. In a number of embodiments, the access point 200 may further include a set of integral antennas configured to generate at least one beam pattern defining a first coverage area from the front end 202A of the access point 200. In a variety of embodiments, the first coverage area may correspond to an area in front of the access point 200. In various embodiments, the access point 200 may further include one or more auxiliary connectors 204A, 204B, 204C, and 204D, for example, extending from the rear end 202B of the access point 200. By way of a non-limiting example, the access point 200 may include four auxiliary connectors 204A-204D extending from the rear end 202B of the access point 200 as illustrated in FIG. 2. The auxiliary connectors 204A-204D may include, for example, multi-RF connectors such as DART connectors, Reverse Polarity-SubMiniature version A (RP-SMA) connectors, SubMiniature version A (SMA) connectors, N-type connectors, Threaded Neill-Concelman (TNC) connectors, RP-TNC connectors, or the like. The auxiliary connectors 204A-204D may be couplable to a set of external antennas to enable generation of one or more beam patterns defining a second coverage area disparate from the first coverage area. In more embodiments, at least one external antenna of the set of external antennas is couplable to any of the auxiliary connectors 204A, 204B, 204C, or 204D via a coaxial interconnect element. The set of external antennas may include, for example, omnidirectional antennas, directional antennas such as patch antennas, sector antennas, dual-band antennas, high-gain antennas, or the like. In additional embodiments, at least one external antenna of the set of external antennas is a direct-mount antenna that can be directly coupled to any of the auxiliary connectors 204A, 204B, 204C, or 204D, for example, without a coaxial interconnect. In further embodiments, the second coverage area may correspond to at least one of an area below the access point 200 or an area behind the access point 200.

Although a specific embodiment for a network device with an auxiliary antenna provision suitable for carrying out the various steps, processes, methods, and operations described herein is discussed with respect to FIG. 2, any of a variety of systems and/or processes may be utilized in accordance with embodiments of the disclosure. For example, although the access point 200 in FIG. 2 shows four auxiliary connectors 204A-204D extending from the rear end 202B of the access point 200, the access point 200 can include any number of auxiliary connectors positioned at different locations on the housing 202 to provide disparate coverage areas. The elements depicted in FIG. 2 may also be interchangeable with other elements of FIG. 1 and FIGS. 3-10 as required to realize a particularly desired embodiment.

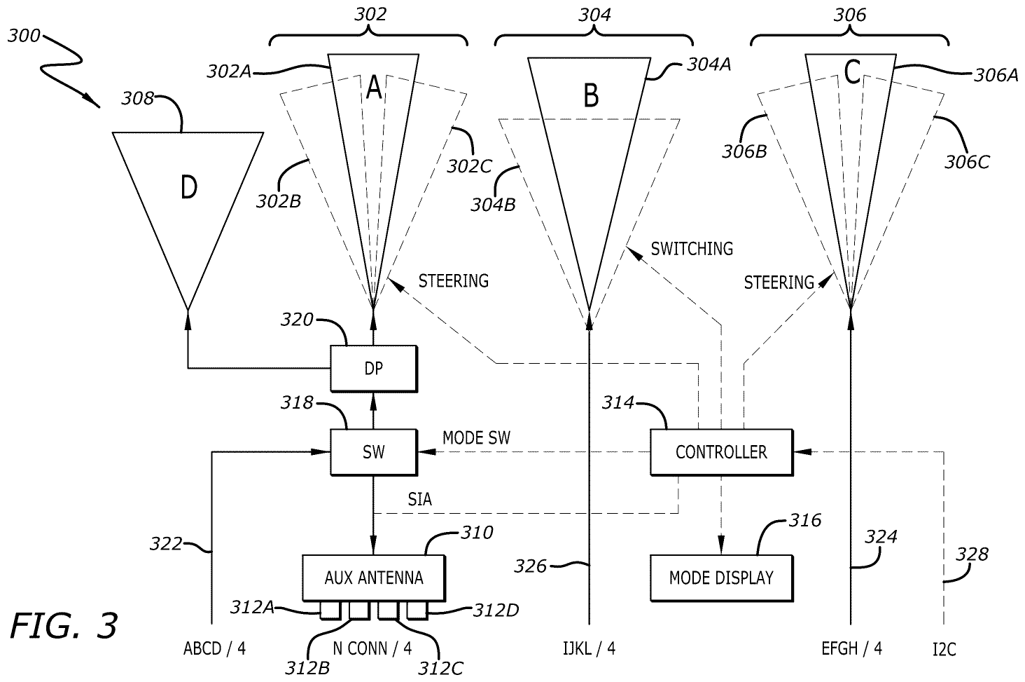

Referring to FIG. 3, a schematic diagram of an architecture of a network device 300 with an auxiliary antenna provision in accordance with various embodiments of the disclosure is shown. In many embodiments, the network device 300 may be an access point including a set of radios that may operate on different frequencies, for example, 2.4 gigahertz (GHz), 5 GHZ, 6 GHz bands, or the like. The network device 300 may facilitate Wi-Fi® connections for various electronic devices, such as but not limited to, mobile computing devices including cellular phones, laptop computers, portable tablet computers, wearable computing devices, or the like. In a number of embodiments, the network device 300 may include a set of integral antennas. For example, the network device 300 may include four integral antennas 302, 304, 306, and 308 (labeled as “A”, “B”, “C”, and “D”, respectively) as illustrated in FIG. 3. Hereinafter, the integral antennas 302, 304, 306, and 308 may be collectively referred to as “the set of integral antennas 302-308”.

In a variety of embodiments, the set of integral antennas 302-308 may include a combination of fixed and steerable antennas, where the fixed antennas may have a predetermined beam direction or coverage pattern and cannot change their orientation, and the steerable antennas may be configured to dynamically change their orientation or beam direction to focus on specific coverage areas as needed. In various embodiments, the set of integral antennas 302-308 may be configured as serving antennas designated for transmitting and receiving RF communication signals to and from client devices in a wireless network environment. In a non-limiting example, the integral antennas 302 and 306 may be steerable, serving antennas configured to operate at a 5 GHz low band and a 5 GHz high or full band, respectively. In another example, the integral antennas 304 and 308 may be fixed, serving antennas configured to operate at a 6 GHz band and a 2.4 GHz band, respectively. In more embodiments, the set of integral antennas 302-308 may be configured to generate at least one beam pattern defining a first coverage area corresponding to an area, for example, in front of the network device 300. In one or more embodiments, the set of integral antennas 302-308 may include, for example, beam-managed, front-facing antennas configured to receive and transmit RF communication signals from a first end, for example, the front end, of the network device 300. In additional embodiments, the set of integral antennas 302-308 may operate in different configurations based on beam switching and beam steering.

In one or more embodiments, the network device 300 may further include a controller 314, a mode display 316, a switch 318, a diplexer 320, a plurality of feedlines 322, 324, and 326, and a communication bus interface 328. In further embodiments, the network device 300 may further include one or more ports operably coupled to the switch 318 or to one or more of the set of integral antennas 302-308. In FIG. 3, for example, a first group of ports labeled as ABCD/4 may be operably coupled to the integral antennas 302 and 308 via the switch 318 and the diplexer 320; a second group of ports labeled as EFGH/4 may be operably coupled to the integral antenna 306; and a third group of ports labeled as IJKL/4 may be operably coupled to the integral antenna 304. The group of ports may herein be referred to as “port groups”. Further, the terms “first”, “second”, and “third” are used herein for descriptive purposes only and are not to be construed to indicate or imply relative importance. In still more embodiments, the port group labeled ABCD/4 may be connected to the switch 318 via the feedline 322; and the port groups labeled EFGH/4 and IJKL/4 may be connected to the integral antennas 306 and 304 via the feedlines 324 and 326, respectively. The plurality of feedlines 322, 324, and 326 may refer to antenna feedlines configured to carry RF communication signals to and from the set of integral antennas 302-308. Further, in some more embodiments, the port groups ABCD/4, EFGH/4, and IJKL/4 may be configured to operate in different RF bands. For example, the port group ABCD/4 may be configured to operate in a 5 gigahertz (GHz) low band and a 2.4 GHz band. In another example, the port group EFGH/4 may be configured to operate in a 5 GHz full band and a 5 GHz high band. In a further example, the port group IJKL/4 may be configured to operate in a 6 GHz band.

The switch 318 may be configured to manage the port group ABCD/4 of the network device 300. In yet various embodiments, the diplexer 320 may be a dual-band diplexer utilized to connect two antennas, for example, the integral antennas 302 and 308 operating on two different frequencies, for example, 5 GHz and 2.4 GHz, respectively, to one common port group, for example, the port group ABCD/4. In yet more embodiments, the port group ABCD/4 may be operably coupled to the switch 318 as illustrated in FIG. 3. In still yet more embodiments, the diplexer 320 may be utilized to split high and low band RF communication signals to isolate a desired frequency transmission. In many further embodiments, the diplexer 320 may separate incoming and outgoing RF communication signals based on their frequency. Consider an example where the diplexer 320 is operably coupled to the integral antennas 302 and 308 operating at 5 GHz and 2.4 GHz bands, respectively. When the network device 300 transmits data, the diplexer 320 may receive RF communication signals from both RF bands, for example, 2.4 GHz and 5 GHz, via the switch 318. For example, the switch 318 may receive 5 GHz and 2.4 GHz RF communication signals from the port group ABCD/4 via the feedline 322 and transmit the RF communication signals to the diplexer 320, which may split the 5 GHZ and 2.4 GHz RF communication signals and pass the 5 GHz RF communication signals to the integral antenna 302 operating in the 5 GHz band, and the 2.4 GHz RF communication signals to the integral antenna 308 operating in the 2.4 GHz band. When receiving RF communication signals, the diplexer 320 may separate the incoming RF communication signals from the integral antennas 302 and 308 based on frequency. For example, the diplexer 320 may direct 2.4 GHz RF communication signals to an appropriate module within the network device 300, while sending the 5 GHz RF communication signals to another module, allowing the network device 300 to process data from both RF bands simultaneously.

In many additional embodiments, the network device 300 may further include one or more auxiliary connectors. For example, in FIG. 3, the network device 300 is shown to include four auxiliary connectors 312A, 312B, 312C, and 312D (hereinafter, collectively referred to as “the auxiliary connectors 312A-312D”). The auxiliary connectors 312A-312D may extend, for example, from a rear end of the network device 300, and may be operably coupled to the switch 318. In still yet further embodiments, the auxiliary connectors 312A-312D may be connected to an internal Printed Circuit Board (PCB) 310 of the network device 300. The auxiliary connectors 312A-312D may be couplable to a set of external antennas to generate one or more beam patterns defining a second coverage area disparate from the first coverage area. In still yet additional embodiments, the second coverage area may correspond to at least one of an area below the network device 300 or an area behind the network device 300. The set of external antennas may include, for example, rear-facing antennas configured to receive and transmit RF communication signals, for example, from the rear end of the network device 300.

In several embodiments, the network device 300 may further include a controller 314. The controller 314 may refer to any one or more microcontrollers, microprocessors, processors such as central processing unit (CPU) devices, finite state machines, computers, digital signal processors, logic, a logic device, an application specific integrated circuit (ASIC), a field-programmable gate array (FPGA), a chip, etc., or any combination thereof, capable of executing computer programs or a series of commands, instructions, or state transitions. In several more embodiments, the controller 314 may be configured to control external antenna provisioning, switching, and steering functions within the network device 300. In numerous embodiments, the controller 314 may be configured to switch the integral antenna 304 from a narrow beamwidth 304A to a wide beamwidth 304B and vice versa. In numerous additional embodiments, the controller 314 may be further configured to steer the directionality of the integral antenna 302, for example, from a vertical direction 302A to a left direction 302B or a right direction 302C. In further additional embodiments, the controller 314 may be further configured to steer the directionality of the integral antenna 306, for example, from a vertical direction 306A to a left direction 306B or a right direction 306C. In many embodiments, the controller 314 may further be configured to operate the switch 318, which may dynamically select which of the integral antennas 302 and 308 to utilize for transmission or reception based on parameters such as signal strength, quality, or specific operational modes (for example, switching between 2.4 GHz and 5 GHz bands). In a variety of embodiments, the switch 318 may work in conjunction with the diplexer 320 to allow multiple external antennas coupled to the auxiliary connectors 312A-312D to transmit and receive data streams simultaneously, enhancing throughput and performance.

In various embodiments, the network device 300 may further support the communication bus interface 328 for one or more communication protocols, for example, an Inter-Integrated Circuit (I2C) protocol, for serial communication. The communication bus interface 328 may be configured to support communication of commands and data between the controller 314 and multiple peripheral devices, for example, an admin device, other target devices, coupled to the network device 300. In more embodiments, the communication bus interface 328 may facilitate reading and writing of configuration settings and status information of the set of external antennas coupled to the auxiliary connectors 312A-312D.

In additional embodiments, the controller 314 may include a control logic configured to detect and provision the set of external antennas coupled to the auxiliary connectors 312A-312D. In further embodiments, the controller 314 may provision the set of external antennas by configuring the set of external antennas based on one or more inputs received via a user interface, herein referred to as the “mode display 316”. In still more embodiments, the controller 314 may provision the set of external antennas by automatically configuring the set of external antennas based on a self-identifying antenna (labelled as “SIA” in FIG. 3) functionality. Consider an example scenario where an external antenna such as a self-identifying antenna may be coupled to one of the auxiliary connectors 312A-312D extending from the rear end of the network device 300. This self-identifying antenna may include a built-in Electrically Erasable Programmable Ready-Only Memory (EEPROM) that can be read by the controller 314 to automatically configure antenna type and gain. In this example scenario, the controller 314 may automatically detect the gain of the self-identifying antenna and adjust its transmission power. In another example, the self-identifying antenna may include a self-identifying device such as an Integrated Circuit (IC) device, or a chip, or circuitry that stores a unique identifier such as a 64-bit serial number. In this example, the controller 314 may query the self-identifying device and acquire the unique identifier to allow provisioning of the self-identifying antenna to the network device 300.

Consider another example scenario where an external antenna such as a legacy-cabled antenna or a non-self-identifying antenna may be coupled to one of the auxiliary connectors 312A-312D, for example, the auxiliary connector 312A. In this example scenario, the controller 314 may automatically detect the external antenna through a combination of electrical signaling and physical connectivity. When the network device 300 powers up, the controller 314 may transmit a signal or voltage through the auxiliary connectors 312A-312D. In such a scenario, the external antenna connected to the auxiliary connector 312A may respond to this signal, indicating their presence and capabilities, thereby allowing the controller 314 to automatically detect the connected external antenna. In another example, the controller 314 may perform an impedance measurement when an external antenna is coupled to any of the auxiliary connectors 312A-312D, for example, the auxiliary connector 312A. By measuring the impedance at the auxiliary connector 312A and comparing the measured impedance with expected values, the controller 314 can infer whether a compatible external antenna is coupled to the auxiliary connector 312A. In another example, the controller 314 may be configured to automatically detect different connector types, for example, N-type, SMA, or the like, of the set of external antennas, and determine which external antennas are coupled to the auxiliary connectors 312A-312D based on their physical coupling.

In still further embodiments, the controller 314 may provision the set of external antennas by re-routing an RF signal path from one or more of the set of integral antennas 302-308 to the auxiliary connectors 312A-312D. In still yet various embodiments, the controller 314 may be further configured to operate the switch 318, which may facilitate switching RF signal paths from different integral antennas, for example, the integral antennas 302 and 308, to one or more of the auxiliary connectors 312A-312D of the network device 300. For example, in response to detecting that an external antenna is coupled to the auxiliary connector 312A, the controller 314 may generate and provide a control signal to the switch 318. Upon receiving the control signal, the switch 318 may re-route an RF signal path, for example, a 2.4 GHz and/or a 5 GHz RF signal path, from the integral antennas 302 and/or 308 to the auxiliary connector 312A, and in turn to the coupled external antenna. In various embodiments, re-routing the RF signal path from an integral antenna of the set of integral antennas 302-308 to an auxiliary connector of the auxiliary connectors 312A-312D may cut off the RF signal path to the integral antenna. In an example, re-routing the RF signal path from the integral antenna to the auxiliary connector may correspond to connecting a radio of the network device 300 to the auxiliary connector upon detecting that a valid external antenna is coupled to the auxiliary connector.

In still additional embodiments, the RF signal path can be selectively re-routed based on a self-identifying antenna discovery process. The controller 314 may be further configured to operate the switch 318, which may facilitate selective re-routing of an RF signal path from the set of integral antennas 302-308 to one or more of the auxiliary connectors 312A-312D. For example, if, during a self-identifying antenna discovery process, the controller 314 detects that an external antenna supporting 2.4 GHz is coupled to the auxiliary connector 312A, the controller 314 may generate the control signal to cause the switch 318 to re-route the 2.4 GHz signal path from the integral antenna 308 to the auxiliary connector 312A, and in turn to the coupled external antenna. In further examples, if, during the self-identifying antenna discovery process, the controller 314 detects that an external antenna supporting 5 GHz is coupled to the auxiliary connector 312A, the controller 314 may generate the control signal to cause the switch 318 to re-route the 5 GHz signal path from the integral antenna 302 to the auxiliary connector 312A, and in turn to the coupled external antenna. In yet further examples, if a first external antenna supporting 2.4 GHz is coupled to the auxiliary connector 312A and a second external antenna supporting 5 GHz is coupled to the auxiliary connector 312B, the control signal generated by the controller 314 may cause the switch 318 to re-route the 2.4 GHz signal path from the integral antenna 308 to the auxiliary connector 312A and the 5 GHz signal path from the integral antenna 302 to the auxiliary connector 312B. In some more embodiments, the controller 314 may be further configured to perform RF power management of the set of external antennas based on antenna gain characteristics. For example, by way of the control signal, the controller 314 can cause the switch 318 to dynamically adjust the transmit power of the set of external antennas based on their antenna gain characteristics, for example, to optimize signal coverage and reduce signal interference in the area below the network device or the area behind the network device. Although in FIG. 3, the switch 318 is shown to be coupled to the integral antennas 302 and 308, the scope of disclosure is not limited to it. In another implementation scenario, the switch 318 may be coupled to any or all of the set of integral antennas 302-308 without deviating from the scope of the disclosure.

Those skilled in the art will recognize that the control logic executed by the controller 314 can also include various hardware and/or software deployments and can be configured in a variety of ways. In still yet more embodiments, the control logic can be configured as a standalone device, exist as a hardware logic or a software logic in the network device 300, be distributed among various network devices operating in tandem, or remotely operated as part of a cloud-based network management tool. In many further embodiments, one or more servers can be configured with the control logic or can otherwise operate as the control logic. In a variety of embodiments, the control logic may operate on one or more servers connected to a communication network, for example, the Internet. The communication network can include wired networks or wireless networks. The control logic can be provided as a cloud-based service that can service remote networks, such as, but not limited to a deployed network. In the embodiment, a plurality of access points can operate as the control logic in a distributed manner or may have one specific device operate as the control logic for all the neighboring or sibling access points.

Although a specific embodiment for an architecture of a network device 300 with an auxiliary antenna provision in accordance with various embodiments of the disclosure suitable for carrying out the various steps, processes, methods, and operations described herein is discussed with respect to FIG. 3, any of a variety of systems and/or processes may be utilized in accordance with embodiments of the disclosure. For example, the set of external antennas coupled to the auxiliary connectors 312A-312D may transmit other information such as frequency bands supported, gain characteristics, and other operational parameters to the controller 314 of the network device 300 to allow the controller 314 to automatically configure the set of external antennas. The elements depicted in FIG. 3 may also be interchangeable with other elements of FIGS. 1-2 and FIGS. 4-10 as required to realize a particularly desired embodiment.

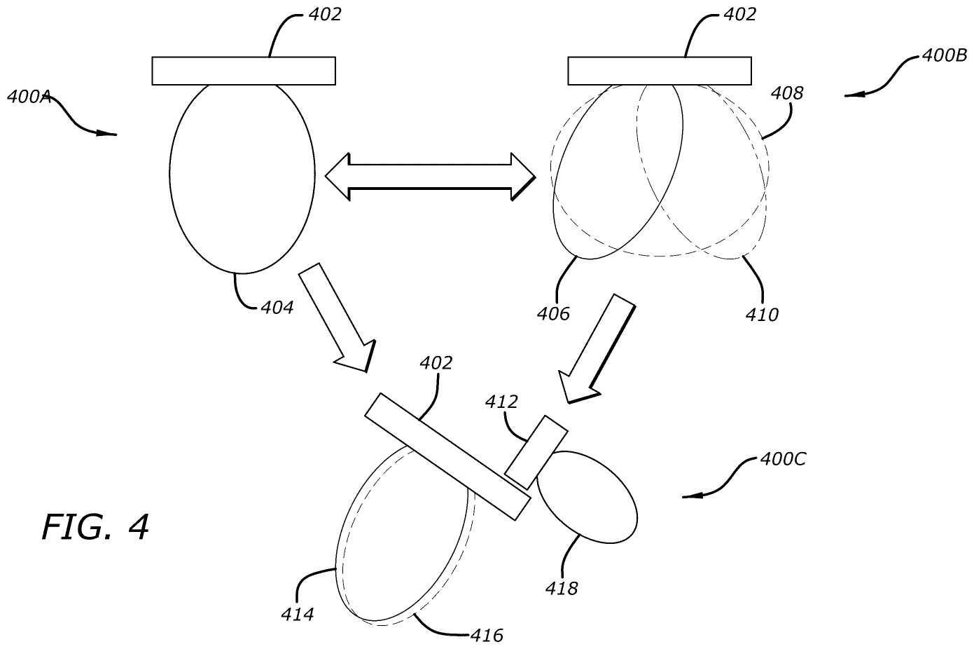

Referring to FIG. 4, a schematic diagram showing different configurations 400A, 400B, and 400C of antennas 402 and 412 for generating one or more beam patterns 404, 406, 408, 410, and 414 in accordance with various embodiments of the disclosure is shown. Consider an example where a set of integral antennas 402 of a network device (for example, an access point) may be configured to operate in a first configuration 400A. In this example, the first configuration 400A may include a single, quad-band cell, where the set of integral antennas 402 may operate across four different frequency bands, for, example, 2.4 GHz, 5 GHz High, 5 GHz Low, and 6 GHz bands. In the first configuration 400A, the set of integral antennas 402 may be configured to generate a beam pattern 404 defining a first coverage area, for example, from a front end of the network device. The generated beam pattern 404 may be a relatively focused beam pattern, which may be utilized for targeting a coverage area, for example, in front of the network device.

Consider another example where the set of integral antennas 402 may be switched to operate in a second configuration 400B from the first configuration 400A. In this example, the second configuration 400B may include dual 5 GHz cells and a 6 GHz supercell. The set of integral antennas 402 may be configured to generate beam patterns 406, 408, and 410 defining coverage areas, for example, from the front end of the network device. In an example, the beam pattern 406 may be a narrow beamwidth incorporating low 5 GHz frequency for targeting a narrow coverage area, for example, in the left direction in front of the network device. In another example, the beam pattern 408 may be a wide beamwidth incorporating 6 GHz frequency for targeting a wider coverage area, for example, in a vertical direction in front of the network device. In another example, the beam pattern 410 may be a narrow beamwidth incorporating high 5 GHz frequency for targeting a narrow coverage area, for example, in the right direction in front of the network device. The wide beamwidth may cover more physical area of an LPV. In many embodiments, the network device may steer the integral antenna beam in primary positions (e.g., −10°, 0°, 10°, etc.) offset in the horizontal plane to point the beam patterns 406, 408, and 410 at a cluster of client devices in the LPV.

Consider another example where the network device may include a provision to couple one or more external antennas thereto. For example, as shown in FIG. 4, in addition to the set of integral antennas 402, a set of external antennas 412 may be coupled to the network device via one or more auxiliary connectors provisioned on the network device. Upon such attachment, the network device may be configured to operate in a third configuration 400C. In this example, the third configuration 400C may include a main cell operating in a 5 GHz low band and a 6 GHz band, and a small cell operating in a 2.5+5 GHz high band. The main cell may be associated with the set of integral antennas 402 and the small cell may be associated with the set of external antennas 412. In a number of embodiments, the third configuration 400C may represent a backfill antenna configuration which is entered by coupling the set of external antennas 412 to the one or more auxiliary connectors of the network device. In a variety of embodiments, the third configuration 400C may be managed through a WLAN controller or a dashboard interface.

The set of integral antennas 402 may be configured to generate beam patterns 414 and 416 defining a coverage area, for example, from the front end of the network device. In an example, the generated beam pattern 414 may be associated with a narrow beamwidth incorporating low 5 GHz frequency. The generated beam pattern 414 may be a relatively focused beam pattern, which may be utilized for targeting a coverage area, for example, in front of the network device. In another example, the generated beam pattern 416 may be associated with a narrow beamwidth incorporating 6 GHz frequency. The generated beam pattern 414 may be a relatively focused beam pattern, which may be utilized for targeting a coverage area, for example, in front of the network device. The set of external antennas 412 may be configured to generate a beam pattern 418 defining coverage areas, for example, below and/or behind the network device. In an example, the generated beam pattern 418 may be associated with a narrow beamwidth incorporating 2.4 GHz and high 5 GHz frequencies. The generated beam pattern 418 may be a relatively focused beam pattern, which may be utilized for targeting coverage areas, for example, below and/or behind the network device.

Although a specific embodiment for different configurations 400A, 400B, and 400C of antennas 402 and 412 for generating one or more beam patterns suitable for carrying out the various steps, processes, methods, and operations described herein is discussed with respect to FIG. 4, any of a variety of systems and/or processes may be utilized in accordance with various embodiments of the disclosure. For example, the network device may be configured to execute an optimization algorithm to determine an optimal antenna configuration for a cluster of client devices in an LPV based on changes in the distribution of client devices at the LPV and/or environmental factors. For example, if there are no client devices behind or underneath a mounting location of the network device, the network device may selectively operate in the first configuration 400A or the second configuration 400B. However, if presence of client devices is detected behind or underneath a mounting location of the network device and the set of external antennas is coupled to the network device, the network device may start operating in the third configuration 400C. The elements depicted in FIG. 4 may also be interchangeable with other elements of FIGS. 1-3 and FIGS. 5-10 as required to realize a particularly desired embodiment.

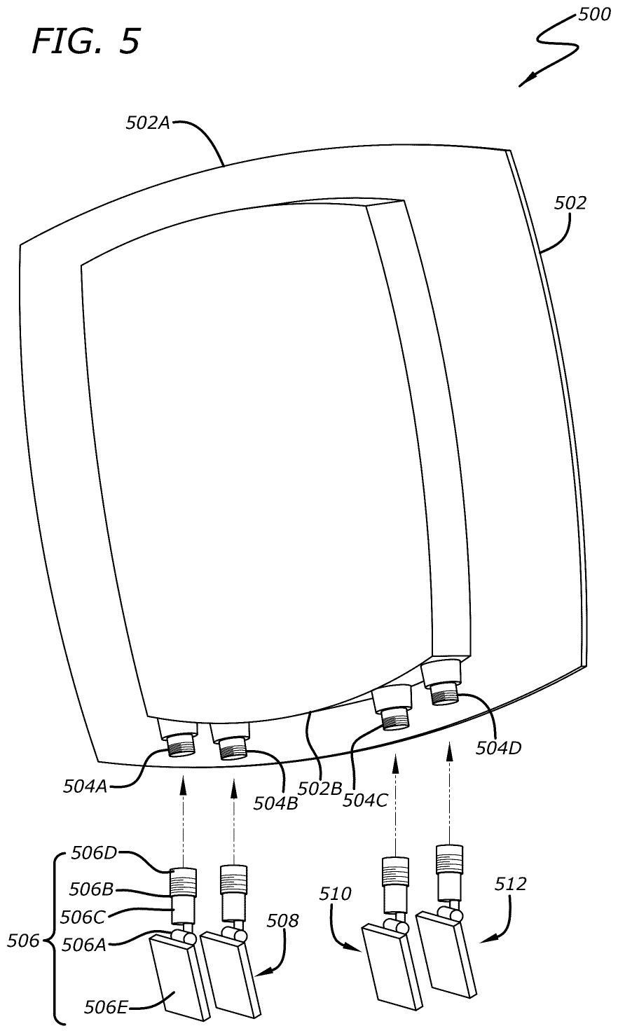

Referring to FIG. 5, a perspective view of a communication system 500 including a network device 502 with an auxiliary antenna provision in accordance with various embodiments of the disclosure is shown. In many embodiments, the network device 502 may include a set of integral antennas and one or more auxiliary connectors 504A, 504B, 504C, and 504D. The integral antennas are configured to generate at least one beam pattern defining a first coverage area from a first end 502A, for example, a front end, of the network device 502. The integral antennas may generate at least one beam pattern defining a front coverage area in front of the network device 502. The auxiliary connectors 504A-504D may extend from a second end 502B, for example, a rear end, of the network device 502. The auxiliary connectors 504A-504D may include, for example, multi-RF connectors such as DART connectors, RP-SMA connectors, SMA connectors, N-type connectors, TNC connectors, RP-TNC connectors, or the like. In a number of embodiments, in addition to the network device 502, the communication system 500 may include a set of custom adjustable, direct-attach, external antennas 506, 508, 510, and 512 couplable to the auxiliary connectors 504A-504D to generate one or more beam patterns defining a second coverage area disparate from the first coverage area. The second coverage area may correspond to at least one of an area below the network device 502 or an area behind the network device 502. In a variety of embodiments, the external antennas 506-512 may include aimable antennas with tilt via hinged connections and rotation via connector positions. These external antennas 506-512 may be cost-effective, save installation labor, and offer a suitable performance for a small cell coverage area below or behind the network device 502 or facing any rearward direction.

In various embodiments, each of the external antennas 506-512 may include a hinged element, a mating connector, and an antenna component coupled to the mating connector via the hinged element. For example, the external antenna 506 may include a hinged element 506A, a mating connector 506B, and an antenna component 506E. In more embodiments, the mating connector 506B may include a first end 506C and a second end 506D. The first end 506C of the mating connector 506B may be coupled to the hinged element 506A and the second end 506D of the mating connector 506B may be rotatably couplable to the auxiliary connector 504A. In additional embodiments, the rotatable coupling of the antenna component 506E to the auxiliary connector 504A via the second end 506D of the mating connector 506B may allow the antenna component 506E to change its orientation in sideways directions, for example, left and right directions. In further embodiments, the rotatable coupling of the antenna component 506E to the auxiliary connector 504A via the second end 506D of the mating connector 506B may allow the antenna component 506E to change its orientation, for example, by about 360 degrees.

The antenna component 506E may be coupled to the mating connector 506B via the hinged element 506A. In still more embodiments, the antenna component 506E may be tiltable via the hinged element 506A. The hinged element 506A may allow the antenna component 506E to move, for example, in an upward direction and a downward direction. The antenna component 506E may be configured to generate an adjustable beam pattern on being coupled to the auxiliary connector 504A. In still further embodiments, each of the external antennas 506-512 may be directly coupled to corresponding auxiliary connectors 504A-D without any additional mount. The mating connectors may be selected based on type of the auxiliary connectors 504A-504D included in the network device 502. For example, if the network device 502 includes SMA connectors as the auxiliary connectors 504A-504D, corresponding SMA connectors may be selected as the mating connectors to couple the external antennas 506-512 to the corresponding auxiliary connectors 504A-504D.

Although a specific embodiment for a communication system 500 including a network device 502 with an auxiliary antenna provision suitable for carrying out the various steps, processes, methods, and operations described herein is discussed with respect to FIG. 5, any of a variety of systems and/or processes may be utilized in accordance with embodiments of the disclosure. For example, other than threaded couplings, the second end 506D of the mating connector 506B of the external antenna 506 may be rotatably couplable to the auxiliary connector 504A of the network device 502 via other coupling mechanisms such as slip fit couplings, slip ring couplings, or the like. The elements depicted in FIG. 5 may also be interchangeable with other elements of FIGS. 1-4 and FIGS. 6-10 as required to realize a particularly desired embodiment.

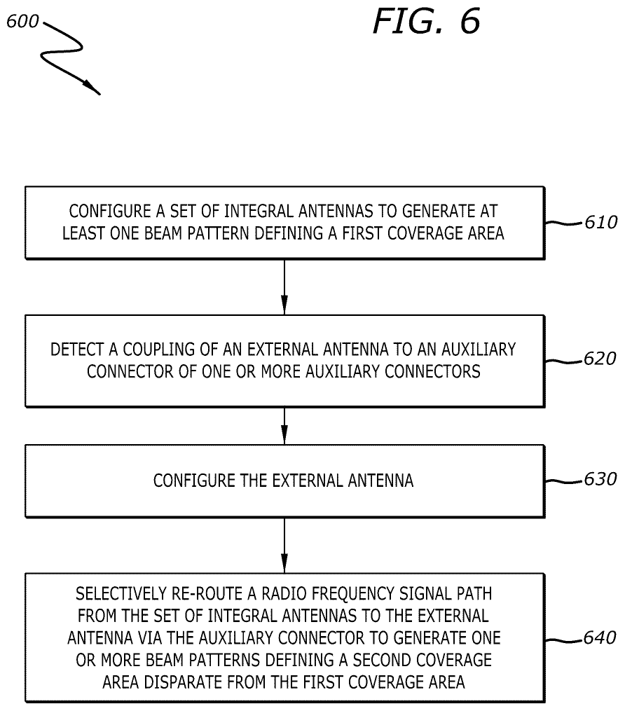

Referring to FIG. 6, a flowchart depicting a process 600 for provisioning an external antenna coupled to an auxiliary connector of a network device in accordance with various embodiments of the disclosure is shown. In many embodiments, the process 600 may configure a set of integral antennas to generate at least one beam pattern defining a first coverage area (block 610). In one or more embodiments, the set of integral antennas may include beam-managed, front-facing antennas configured to receive and transmit RF communication signals, for example, from a front end of the network device. In a number of embodiments, the set of integral antennas may include, for example, directional antennas, MIMO antennas, dual-band antennas, integrate antenna arrays, or the like. In a variety of embodiments, the first coverage area may correspond to an area in front of the network device. The configuration of the set of integral antennas may include, for example, steering one or more integral antennas, adjusting phase and amplitude of the RF communication signals transmitted to the set of integral antennas, configuring polarization of the set of integral antennas such as vertical, horizontal, or circular, a MIMO configuration, or the like. In various embodiments, the process 600 may switch one or more integral antennas to a wide beamwidth to find client devices with locate services of the network device. When a higher density cluster of client devices is identified, the process 600 may switch to a narrow beamwidth. Further, the process 600 may steer the beam pattern in primary positions (e.g., −10°, 0°, 10°, etc.) offset in a horizontal plane to point a narrow beam at the cluster.

In more embodiments, the process 600 may detect a coupling of an external antenna to an auxiliary connector of one or more auxiliary connectors (block 620). The network device may include the one or more auxiliary connectors extending, for example, from a rear end of the network device. An external antenna may be coupled to any one of the auxiliary connectors. In additional embodiments, the external antenna may include a rear-facing antenna configured to receive and transmit RF communication signals, for example, from the rear end of the network device. Consider an example scenario where an external antenna such as a self-identifying antenna may be coupled to one of the auxiliary connectors. The self-identifying antenna can include a built-in EEPROM, an IC device, a chip, or circuitry that stores a unique identifier of the self-identifying antenna. The process 600 may read the unique identifier and detect the coupling of the external antenna to the auxiliary connector. Consider another example scenario where an external antenna such as a non-self-identifying antenna may be coupled to one of the auxiliary connectors. In this example scenario, the process 600 may detect the external antenna through a combination of electrical signaling and physical connectivity. In another example, the process 600 may detect a different connector type, for example, N-type, SMA, or the like, of the external antenna, and determine which external antenna is coupled to the auxiliary connector based on their physical coupling.

In still more embodiments, the process 600 may configure the external antenna (block 630). The process 600 may configure the external antenna for provisioning the external antenna. In still further embodiments, the process 600 may configure the external antenna based on one or more inputs received via a user interface. For example, the network device may include a mode display configured to provide the user interface to receive inputs from operators of the network device. The operators may enter configuration parameters including, for example, gain, polarization, tilt angles, frequency band, power output, channels, or the like, to configure the external antenna via the user interface. In some more embodiments, the process 600 may automatically configure the external antenna based on a self-identifying antenna functionality. For example, when a self-identifying external antenna is coupled to the auxiliary connector, the process 600 may automatically detect the gain of the self-identifying antenna during the self-identifying antenna discovery process and adjust its transmission power. In another example, the process 600 may read various antenna parameters from EEPROM, IC device, the chip, or circuitry of the external antenna and configure the self-identifying antenna based on the antenna parameters.

In yet various embodiments, the process 600 may selectively re-route an RF signal path from the set of integral antennas to the external antenna via the auxiliary connector to generate one or more beam patterns defining a second coverage area disparate from the first coverage area (block 640). In yet more embodiments, the second coverage area may correspond to at least one of an area below the network device or an area behind the network device. In an example, the process 600 may selectively re-route a 2.4 GHz and a 5 GHz RF signal path from the set of integral antennas to the auxiliary connector. In still yet more embodiments, the process 600 may selectively re-route the RF signal path from the set of integral antennas to the auxiliary connector via a self-identifying antenna discovery process. For example, if, during the self-identifying antenna discovery process, the process 600 detects that the external antenna supports 2.4 GHz frequency band, the process 600 may re-route the 2.4 GHz signal path from the set of integral antennas to the auxiliary connector to which the external antenna is coupled. In further example, if, during the self-identifying antenna discovery process, the process 600 detects that the external antenna supports 5 GHz frequency band, the process 600 may re-route the 5 GHz signal path from the set of integral antennas to the auxiliary connector, and in turn to the coupled external antenna. On receiving the re-routed RF signal path from the auxiliary connector, in many further embodiments, the external antenna may generate the one or more beam patterns defining the second coverage area disparate from the first coverage area. For example, the external antenna may generate a beam pattern defining coverage areas below and/or behind the network device, which are disparate from the front coverage area defined by the beam pattern(s) generated by the set of integral antennas.

Although a specific embodiment for a process 600 for provisioning an external antenna coupled to an auxiliary connector of a network device suitable for carrying out the various steps, processes, methods, and operations described herein is discussed with respect to FIG. 6, any of a variety of systems and/or processes may be utilized in accordance with embodiments of the disclosure. For example, the process 600 may implement machine learning or Artificial Intelligence (AI) for analyzing historical data and predicting optimal beam patterns to be generated for defining optimal coverage areas in front of, below, and/or behind a mounting location of the network device. The elements depicted in FIG. 6 may also be interchangeable with other elements of FIGS. 1-5 and FIGS. 7-10 as required to realize a particularly desired embodiment.

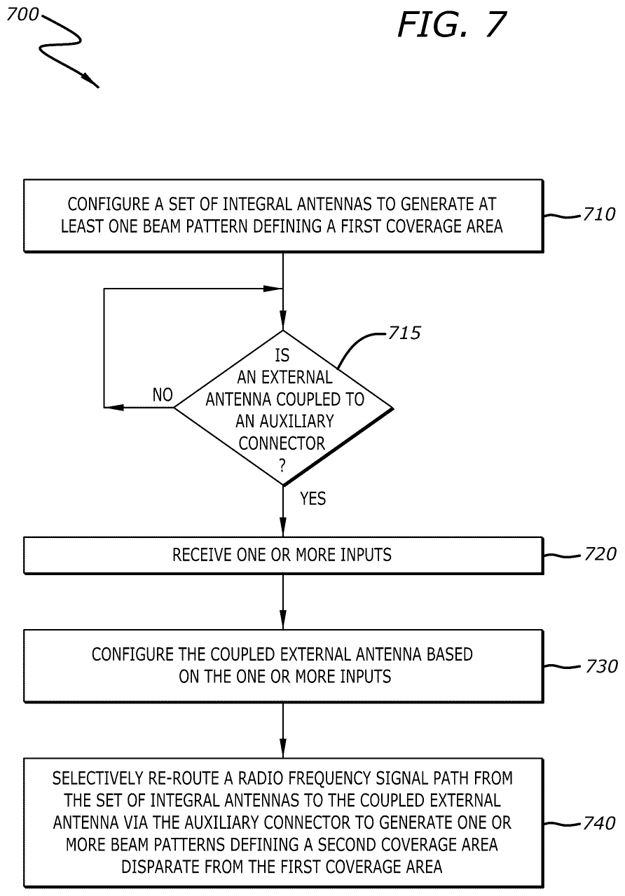

Referring to FIG. 7, a flowchart depicting a process 700 for detecting and provisioning an external antenna coupled to an auxiliary connector of a network device based on one or more user inputs in accordance with various embodiments of the disclosure is shown. In many embodiments, the process 700 may configure a set of integral antennas to generate at least one beam pattern defining a first coverage area (block 710). In a number of embodiments, the first coverage area may correspond to an area in front of the network device. The configuration of the set of integral antennas may include, for example, steering the integral antennas, adjusting phase and amplitude of the RF communication signals transmitted to the set of integral antennas, configuring polarization of the integral antennas such as vertical, horizontal, or circular, a MIMO configuration, or the like. In a variety of embodiments, the process 700 may configure the set of integral antennas to face forward and focus their energy in a forward direction to generate at least one beam pattern defining the coverage area in front of the network device. In various embodiments, the process 700 may construct at least one beam pattern directed toward client devices, for example, in an LPV, in front of the network device.

In more embodiments, the process 700 may determine whether an external antenna is coupled to an auxiliary connector (block 715). An external antenna may be coupled to any one of the auxiliary connectors extending, for example, from a rear end of the network device. When the external antenna is coupled to one of the auxiliary connectors of the network device, in additional embodiments, the process 700 may automatically detect the coupling of the external antenna to the auxiliary connector of the network device. For example, if an external self-identifying antenna is coupled to an auxiliary connector of the network device, the process 700 may execute a self-identifying functionality to automatically detect the coupling of the external self-identifying antenna to the auxiliary connector of the network device. In further embodiments, the process 700 may transmit a small signal or voltage through the auxiliary connector and await a response to this signal from an external antenna. In still more embodiments, the process 700 may sense a physical connection to the auxiliary connector based on a connector type detection or by utilizing sensors. In still further embodiments, the process 700 may check for the presence of an RF communication signal from an external antenna at the auxiliary connector. In still additional embodiments, the process 700 may perform an impedance check on the auxiliary connector. A properly connected external antenna may have a specific impedance, for example, about 50 ohms. If the measured impedance deviates significantly from the expected impedance, the process 700 may infer that an external antenna is not coupled to the auxiliary connector.

In some more embodiments, in response to determining that an external antenna is coupled to an auxiliary connector, the process 700 may receive one or more inputs (block 720). The process 700 may render a user interface for allowing an operator of the network device to enter the one or more inputs associated with configuration of the external antenna. The operator may enter configuration parameters including, for example, transmit power, antenna gain, effective isotropic radiated power, frequency bands, or the like, via the user interface.

In yet various embodiments, the process 700 may configure the coupled external antenna based on the one or more inputs (block 730). In response to receiving the one or more inputs including the configuration parameters for the external antenna via the user interface, the process 700 may execute a control logic to configure the coupled external antenna based on the received inputs. In yet more embodiments, the process 700 may configure the coupled external antenna to operate in a configuration including, for example, a main cell operating in a 5 GHz low band and a 6 GHz band and a small cell operating in a 2.5+5 GHz high band.

In still yet more embodiments, the process 700 may selectively re-route an RF signal path from the set of integral antennas to the coupled external antenna via the auxiliary connector to generate one or more beam patterns defining a second coverage area disparate from the first coverage area (block 740). In many further embodiments, the second coverage area may correspond to at least one of an area below the network device or an area behind the network device. In an example, the process 700 may selectively re-route a 2.4 GHz and a 5 GHz RF signal path from the set of integral antennas to the auxiliary connector. In many additional embodiments, the process 700 may selectively re-route the RF signal path from the integral antennas to the auxiliary connector via a self-identifying antenna discovery process. The process 700 may allow the auxiliary connector to selectively re-route the RF signal path to the coupled external antenna. On receiving the re-routed RF signal path from the auxiliary connector, in still yet further embodiments, the external antenna may generate the one or more beam patterns defining the second coverage area disparate from the first coverage area. For example, the external antenna may generate a beam pattern defining a coverage area below and/or behind the network device, which is disparate from the front coverage area defined by the beam pattern(s) generated by the set of integral antennas.

However, in numerous additional embodiments, in response to determining that there is no external antenna coupled to an auxiliary connector, the process 700 may continue determining whether an external antenna is coupled to an auxiliary connector (block 715) as described above. In still yet additional embodiments, the process 700 may iteratively transmit a small signal or voltage through the auxiliary connector and await a response to this signal. In several embodiments, the process 700 may iteratively sense a physical connection to the auxiliary connector based on a connector type detection or by utilizing sensors. In several more embodiments, the process 700 may iteratively check for the presence of an RF communication signal from an external antenna at the auxiliary connector. In numerous embodiments, the process 700 may iteratively perform an impedance check on the auxiliary connector. In one or more embodiments, the process 700 may perform these checks at periodic time intervals or at random time intervals to determine whether an external antenna is coupled to an auxiliary connector or not.

Although a specific embodiment for a process 700 for detecting and provisioning an external antenna coupled to an auxiliary connector of a network device based on one or more user inputs suitable for carrying out the various steps, processes, methods, and operations described herein is discussed with respect to FIG. 7, any of a variety of systems and/or processes may be utilized in accordance with embodiments of the disclosure. For example, in numerous additional embodiments, the process 700 may configure the set of integral antennas to be utilized as either dual-band antennas or as single-band antennas to optimize radio coverage. In a dual-band antenna mode, for example, the process 700 may configure the set of integral antennas to operate in both the 2.4 GHz and 5 GHz bands. In further additional embodiments, the process 700 may configure the set of integral antennas to operate in a dual-band mode or a single-band mode. The elements depicted in FIG. 7 may also be interchangeable with other elements of FIGS. 1-6 and FIGS. 8-10 as required to realize a particularly desired embodiment.

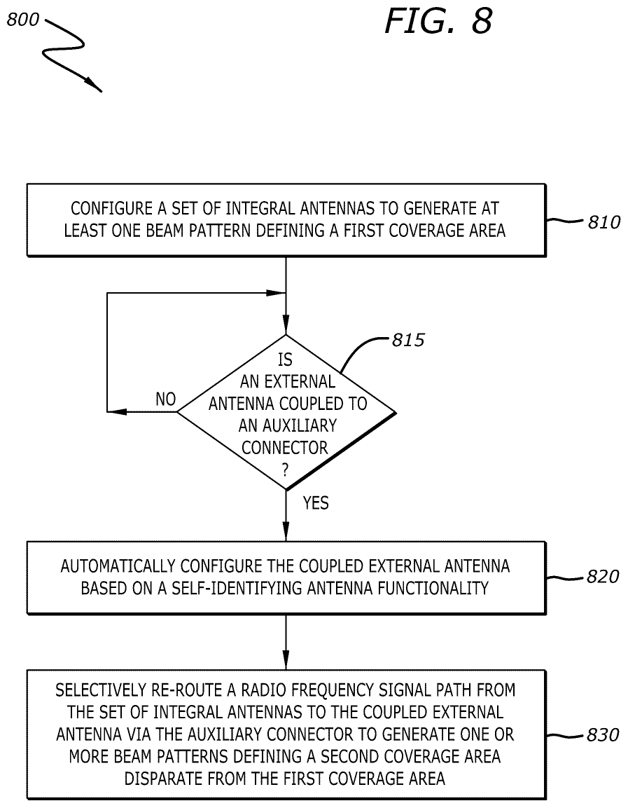

Referring to FIG. 8, a flowchart depicting a process 800 for detecting and automatically provisioning an external antenna coupled to an auxiliary connector of a network device based on a self-identifying antenna functionality in accordance with various embodiments of the disclosure is shown. In many embodiments, the process 800 may configure a set of integral antennas to generate at least one beam pattern defining a first coverage area (block 810). In a number of embodiments, the first coverage area may correspond to an area in front of the network device. The configuration of the set of integral antennas may include, for example, steering the integral antennas, adjusting phase and amplitude of the RF communication signals transmitted to the set of integral antennas, configuring polarization of the set of integral antennas such as vertical, horizontal, or circular, a MIMO configuration, or the like.

In more embodiments, the process 800 may determine whether an external antenna is coupled to an auxiliary connector (block 815). An external antenna may be coupled to any one of the auxiliary connectors extending, for example, from a rear end of the network device. When the external antenna is coupled to one of the auxiliary connectors of the network device, in additional embodiments, the process 800 may automatically detect the coupling of the external antenna to the auxiliary connector of the network device. For example, if an external self-identifying antenna is coupled to an auxiliary connector of the network device, the process 800 may execute a self-identifying functionality to automatically detect the gain of the external self-identifying antenna and in turn, the coupling of the external self-identifying antenna to the auxiliary connector of the network device.

In further embodiments, in response to determining that an external antenna is coupled to an auxiliary connector, the process 800 may automatically configure the coupled external antenna based on a self-identifying antenna functionality (block 820). Consider an example scenario where an external antenna such as a self-identifying antenna may be coupled to an auxiliary connector extending from the rear end of the network device. This self-identifying antenna may include a built-in EEPROM that can be read by the controller of the network device to automatically configure the antenna type and gain. In this example scenario, the process 800 may automatically detect the gain of the self-identifying antenna and adjust its transmit power. In another example, the self-identifying antenna may include a self-identifying device such as an IC device, or a chip, or circuitry that stores a unique identifier such as a 64-bit serial number. In this example, the process 800 may query the self-identifying device and acquire the unique identifier to allow automatic configuration of the self-identifying antenna in the network device. In another example, the self-identifying antenna may include an identification circuit with predetermined antenna characteristics coded thereinto. The predetermined antenna characteristics may include any suitable type of information that can be utilized for identifying the self-identifying antenna or its properties. For example, the antenna characteristics can include the level of antenna gain and its associated maximum output power, desired operation of the self-identifying antenna, selection of a preferred operational frequency band, or the like. In this example, the identification circuit may be configured to “read out” the programmed antenna characteristics for transmitting an “identification stream” through the auxiliary connector to the controller of the network device. The process 800 may execute an algorithm for receiving the identification stream including the predetermined antenna characteristics to allow automatic configuration of the self-identifying antenna in the network device.

In still more embodiments, the process 800 may selectively re-route a radio frequency signal path from the set of integral antennas to the coupled external antenna via the auxiliary connector to generate one or more beam patterns defining a second coverage area disparate from the first coverage area (block 830). In still further embodiments, the second coverage area may correspond to at least one of an area below the network device or an area behind the network device. In an example, the process 800 may selectively re-route a 2.4 GHz and a 5 GHz RF signal path from the set of integral antennas to the auxiliary connector. In still additional embodiments, the process 800 may selectively re-route the RF signal path from the set of integral antennas to the auxiliary connector via a self-identifying antenna discovery process. The process 800 may allow the auxiliary connector to selectively re-route the RF signal path to the coupled external antenna. On receiving the re-routed RF signal path from the auxiliary connector, in some more embodiments, the external antenna may generate one or more beam patterns defining the second coverage area disparate from the first coverage area. For example, the external antenna may generate one or more beam patterns defining coverage areas below and behind the network device, which are disparate from the front coverage area defined by the beam pattern(s) generated by the integral antennas.

However, in yet various embodiments, in response to determining that there is no external antenna coupled to an auxiliary connector, the process 800 may iteratively determine whether an external antenna is coupled to an auxiliary connector (block 815). In yet more embodiments, the process 800 may iteratively transmit a small signal or voltage through the auxiliary connector and await a response to this signal. In still yet more embodiments, the process 800 may iteratively sense a physical connection to the auxiliary connector based on a connector type detection or by utilizing sensors. In many further embodiments, the process 800 may iteratively check for the presence of an RF communication signal from an external antenna at the auxiliary connector. In many additional embodiments, the process 800 may iteratively perform an impedance check on the auxiliary connector.

Although a specific embodiment for a process 800 for detecting and automatically provisioning an external antenna coupled to an auxiliary connector of a network device based on a self-identifying antenna functionality suitable for carrying out the various steps, processes, methods, and operations described herein is discussed with respect to FIG. 8, any of a variety of systems and/or processes may be utilized in accordance with embodiments of the disclosure. For example, other than the self-identifying antenna functionality, the process 800 may implement different configuration protocols such as a simple network management protocol, a link layer discovery protocol, or proprietary protocols to automatically identify the antenna type, capabilities, and optimal settings and provision the external antenna coupled to the auxiliary connector of the network device. The elements depicted in FIG. 8 may also be interchangeable with other elements of FIGS. 1-7 and FIGS. 9-10 as required to realize a particularly desired embodiment.

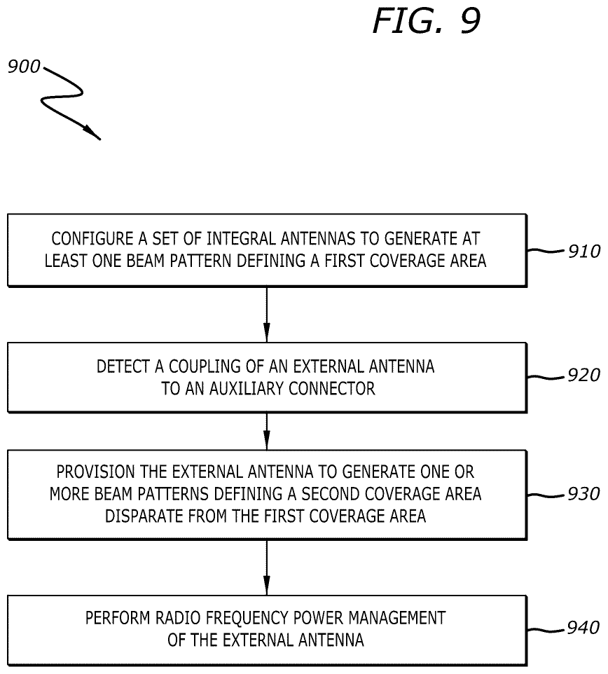

Referring to FIG. 9, a flowchart depicting a process 900 for detecting and automatically managing an external antenna coupled to an auxiliary connector of a network device in accordance with various embodiments of the disclosure is shown. In still yet further embodiments, the process 900 may configure a set of integral antennas to generate at least one beam pattern defining a first coverage area (block 910). In still yet additional embodiments, the first coverage area may correspond to an area in front of the network device. The configuration of the set of integral antennas may include, for example, steering the integral antennas, adjusting phase and amplitude of the RF communication signals transmitted to the integral antennas, configuring polarization of the integral antennas such as vertical, horizontal, or circular, a MIMO configuration, or the like.

In several more embodiments, the process 900 may detect a coupling of an external antenna to an auxiliary connector (block 920). An external antenna may be coupled to any one of the auxiliary connectors extending, for example, from a rear end of the network device. When the external antenna is coupled to one of the auxiliary connectors of the network device, in numerous embodiments, the process 900 may automatically detect the coupling of the external antenna to the auxiliary connector of the network device. For example, if an external self-identifying antenna is coupled to an auxiliary connector of the network device, the process 900 may execute a self-identifying functionality to automatically detect the coupling of the external self-identifying antenna to the auxiliary connector of the network device.

In numerous additional embodiments, the process 900 may provision the external antenna to generate one or more beam patterns defining a second coverage area disparate from the first coverage area (block 930). In further additional embodiments, the process 900 may provision the external antenna by configuring the external antenna based on one or more inputs received via a user interface. In many embodiments, the process 900 may provision the external antenna by automatically configuring the external antenna based on a self-identifying antenna functionality. In a number of embodiments, the process 900 may provision the external antenna by selectively re-routing an RF signal path from the set of integral antennas to the auxiliary connector. In a variety of embodiments, the process 900 may selectively re-route the RF signal path from the set of integral antennas to the auxiliary connector based on a self-identifying antenna discovery process. For example, if, during the self-identifying antenna discovery process, the process 900 detects that the external antenna supports 2.4 GHz frequency band, the process 900 may re-route a 2.4 GHz signal path from the set of integral antennas to the auxiliary connector to which the external antenna is coupled. In further example, if, during the self-identifying antenna discovery process, the process 900 detects that the external antenna supports 5 GHz frequency band, the process 900 may re-route a 5 GHz signal path from the set of integral antennas to the auxiliary connector, and in turn to the coupled external antenna.

In various embodiments, the process 900 may perform RF power management of the external antenna (block 940). In more embodiments, the process 900 may execute a control logic configured to perform RF power management of the external antenna based on antenna gain characteristics. Power from an external antenna may be measured as Effective Isotropic Radiated Power (EIRP). EIRP may be calculated by adding transmit power in decibel milliwatts (dBm) to the antenna gain in decibels relative to isotropic (dBi) and subtracting any cable losses in dB. In additional embodiments, the process 900 may consider output power and antenna gain to ensure compliance with regulatory standards that define a maximum EIRP. In further embodiments, the process 900 may adjust its RF power output based on the gain of the coupled external antenna. For example, if a high-gain external antenna is coupled to the auxiliary connector of the network device, the process 900 may reduce its power output to prevent signal overload and interference. In still more embodiments, the process 900 may execute the control logic to automatically adjust transmit power based on current network conditions, user density, and distance to client devices. In still further embodiments, the process 900 may monitor signal quality (e.g., Signal-to-Noise Ratio, Received Signal Strength Indicator “RSSI”) and can dynamically adjust power levels in real time. For example, if the RF communication signal is too strong, the process 900 may reduce power to avoid interference with nearby client devices. In still additional embodiments, the process 900 may set predefined power thresholds to ensure the network device with the coupled external antenna operates within regulatory limits and avoids excessive power usage. These predefined power thresholds can trigger automatic adjustments if exceeded. In some more embodiments, to support Multi-User MIMO (MU-MIMO), the process 900 may allow the network device to allocate power across multiple streams effectively. When using beamforming techniques, the process 900 may adjust power levels to optimize an effective range and directionality of the RF communication signal based on the gain characteristics of the coupled external antenna. In high-density environments such as LPVs, the process 900 may manage RF power to balance load and maintain quality connections, considering the gain characteristics of the coupled external antenna in use.

Although a specific embodiment for a process 900 for detecting and automatically managing an external antenna to an auxiliary connector of a network device suitable for carrying out the various steps, processes, methods, and operations described herein is discussed with respect to FIG. 9, any of a variety of systems and/or processes may be utilized in accordance with embodiments of the disclosure. For example, the process 900 may utilize AI and/or machine learning models to optimize overall power consumption of the network device and/or individual path power consumption, to optimize for overall system throughput performance and individual flow throughput performance, to adjust and enable/disable or configure interfaces/modules, and to dynamically learn the traffic profile and user configuration/setup and/or behavior. The elements depicted in FIG. 9 may also be interchangeable with other elements of FIGS. 1-8 and FIG. 10 as required to realize a particularly desired embodiment.

Referring to FIG. 10, a conceptual block diagram of a device 1000 capable of executing components and logic for implementing the functionality and embodiments described above is shown. The embodiment of the conceptual block diagram depicted in FIG. 10 can illustrate a conventional server computer, a workstation, a desktop computer, a laptop, a tablet, a network appliance, an electronic reader (e-reader), a smartphone, or other computing device, and can be utilized to execute any of the application and/or logic components presented herein. The device 1000 may, in some examples, correspond to a physical device or to a virtual resource described herein. The device 1000 can be a network device (for example, an access point or a WLAN controller), a client device, or the like in accordance with various embodiments of the disclosure.

In many embodiments, the device 1000 may include an environment 1002 such as a baseboard or a “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In a number of embodiments, one or more processors 1004, such as, but not limited to, central processing units (CPUs) can be configured to operate in conjunction with a chipset 1006. The processor(s) 1004 can be standard programmable CPUs that perform arithmetic and logical operations necessary for the operation of the device 1000.

In a variety of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (RAM) 1008, which can be utilized as the main memory in the device 1000 in some embodiments. The chipset 1006 can further be configured to provide an interface to a computer-readable storage medium such as a read-only memory (ROM) 1010 or a Non-Volatile RAM (NVRAM) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Different embodiments of the device 1000 can be configured to operate in a networked environment using logical connections to remote computing devices and computer systems through a network, such as the network 1040. The chipset 1006 can include functionality for providing network connectivity through a network interface controller (NIC) 1012, which may include a gigabit Ethernet adapter or similar component. The NIC 1012 can be capable of connecting the device 1000 to other devices over the network 1040. It is contemplated that multiple NICs 1012 may be present in the device 1000, connecting the device 1000 to other types of networks and remote systems.

In more embodiments, the device 1000 can be connected to a storage 1018 that provides non-volatile storage for data accessible by the device 1000. The storage 1018 can, for example, store an operating system 1020, applications or programs 1022, integral antenna characteristic data 1028, external antenna characteristic data 1030, and configuration data 1032, which are described in greater detail below. The storage 1018 can be connected to the environment 1002 through a storage controller 1014 connected to the chipset 1006. In additional embodiments, the storage 1018 can include one or more physical storage units. The storage controller 1014 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology utilized to implement the physical storage units, whether the storage 1018 is characterized as primary or secondary storage, and the like. For example, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to the device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, Erasable programmable ROM (EPROM), Electrically-Erasable programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1018 can store an operating system 1020 utilized to control the operation of the device 1000. According to one embodiment, the operating system 1020 includes the LINUX operating system. According to another embodiment, the operating system 1020 includes the WINDOWS® SERVER operating system from MICROSOFT Corporation of Redmond, Washington. According to further embodiments, the operating system 1020 can include the UNIX operating system or one of its variants. It should be appreciated that other operating systems can also be utilized. The storage 1018 can store other system or application programs and data utilized by the device 1000.

In still more embodiments, the storage 1018 or other computer-readable storage media is encoded with computer-executable instructions which, when loaded into the device 1000, may transform the device 1000 from a general-purpose computing system into a special-purpose computer capable of implementing the embodiments described herein. These computer-executable instructions may be stored as applications or programs 1022 and transform the device 1000 by specifying how the processor(s) 1004 can transition between states, as described above. In still further embodiments, the device 1000 has access to computer-readable storage media storing computer-executable instructions which, when executed by the device 1000, perform the various processes described above with regard to FIGS. 1-10. In still additional embodiments, the device 1000 can also include computer-readable storage media having instructions stored thereupon for performing any of the other computer-implemented operations described herein.

In some more embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 may not include all of the components shown in FIG. 10, and can include other components that are not explicitly shown in FIG. 10, or may utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

In yet various embodiments, the device 1000 can include a control logic 1024 that may be responsible for detecting and provisioning a set of external antennas coupled to one or more auxiliary connectors of the device 1000. In embodiments where the device 1000 corresponds to a network device, the control logic 1024 can be configured to perform various operations such as, but not limited to, configuring the set of external antennas based on one or more inputs received via a user interface, automatically configuring the set of external antennas based on a self-identifying antenna functionality, and selectively re-routing an RF signal path from a set of integral antennas to the auxiliary connector(s). In yet more embodiments, the control logic 1024 may also be responsible for performing RF power management of the set of external antennas based on antenna gain characteristics.

In still yet more embodiments, the device 1000 may correspond to a network device such as a WLAN controller. In such embodiments, the control logic 1024 can be configured to perform various operations such as, but not limited to, monitoring or controlling power consumption of the network devices in an LPV, and configuring the set of integral antennas and the external antennas coupled to the network device to a determined antenna vector or parameters to create coverage areas that serve client device clusters in the LPV.

In many further embodiments, the storage 1018 can include integral antenna characteristic data 1028. The integral antenna characteristic data 1028 may relate to data representative of the set of integral antennas included in the network device. For example, the integral antenna characteristic data 1028 may include antenna type, antenna gain, frequency range, polarization, size and form factor, radiation pattern information, efficiency metrics, or the like. The integral antenna characteristic data 1028 may be utilized by the control logic 1024 to configure the set of integral antennas for generating at least one beam pattern defining, for example, a front coverage area, from the front end of the network device.

In many additional embodiments, the storage 1018 can include external antenna characteristic data 1030. The external antenna characteristic data 1030 may relate to data representative of external antennas couplable to the auxiliary connectors extending, for example, from a rear end of the network device. The external antenna characteristic data 1030 can include, but is not limited to, antenna type, antenna gain, frequency range, polarization, size and form factor, radiation pattern information, efficiency metrics, or the like. The external antenna characteristic data 1030 may be utilized by the control logic 1024 to configure the external antennas for generating one or more beam patterns defining, for example, a rear coverage area disparate from the front coverage area.

In still yet further embodiments, the storage 1018 can include configuration data 1032. The configuration data 1032 may relate to data representative of the configuration of the set of external antennas couplable to the auxiliary connectors of the network device. For example, the configuration data 1032 may include inputs received via a user interface from an operator of the network device. In another example, the configuration data 1032 may include gain, polarization, beamwidth, the azimuth, the beam elevation, tilt angles, frequency band, power output, channels, or the like, associated with the external antennas coupled to the auxiliary connectors of the network device.

Finally, in still yet additional embodiments, data may be processed into a format usable by a machine-learning (“ML”) model 1026 (e.g., feature vectors), and or other pre-processing techniques. The ML model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models. The ML model 1026 may be configured to analyze the integral antenna characteristic data 1028, the external antenna characteristic data 1030, and the configuration data 1032 for configuring and provisioning the external antennas to the auxiliary connectors of the network device. In several embodiments, the ML model 1026 may be utilized to identify various parameters to include in the configuration data 1032. For example, the ML model 1026 may analyze the configuration data 1032 and identify parameters that are required to augment the configuration data 1032. Once the parameters are identified, the control logic 1024 may utilize the parameters to configure and provision the external antennas to the auxiliary connectors of the network device. In several more embodiments, the ML model 1026 may facilitate selective re-routing of an RF signal path from the set of integral antennas to the auxiliary connectors. For example, the ML model 1026 may be configured to receive signal metrics such as signal strength, antenna gain, beam patterns, signal path data, and frequency band data as input and identify trends that affect signal quality and coverage. The control logic 1024 may then utilize trained models to predict the best RF signal path based on current conditions and anticipated changes, optimizing re-routing decisions dynamically.

Although a specific embodiment for a device 1000 suitable for configuration with the control logic 1024 for carrying out the various steps, processes, methods, and operations described herein is discussed with respect to FIG. 10, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the control logic 1024 acts in tandem between the devices. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary”, or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a set of integral antennas configured to generate at least one beam pattern defining a first coverage area from a first end of the network device; and
one or more auxiliary connectors extending from a second end of the network device, wherein the one or more auxiliary connectors are couplable to a set of external antennas to generate one or more beam patterns defining a second coverage area disparate from the first coverage area.

2. The network device of claim 1, wherein the set of integral antennas comprises beam-managed, front-facing antennas configured to receive and transmit radio frequency communication signals from the first end of the network device.

3. The network device of claim 1, wherein the set of external antennas comprises rear-facing antennas configured to receive and transmit radio frequency communication signals from the second end of the network device.

4. The network device of claim 1, further comprising a control logic configured to detect and provision the set of external antennas coupled to the one or more auxiliary connectors.

5. The network device of claim 4, wherein provisioning the set of external antennas comprises configuring the set of external antennas based on one or more inputs received via a user interface.

6. The network device of claim 4, wherein provisioning the set of external antennas comprises automatically configuring the set of external antennas based on a self-identifying antenna functionality.

7. The network device of claim 4, wherein provisioning the set of external antennas comprises selectively re-routing a radio frequency signal path from the set of integral antennas to the one or more auxiliary connectors.

8. The network device of claim 7, wherein the radio frequency signal path is selectively re-routed based on a self-identifying antenna discovery process.

9. The network device of claim 4, wherein the control logic is further configured to perform radio frequency power management of the set of external antennas based on antenna gain characteristics.

10. The network device of claim 1, wherein the first coverage area corresponds to an area in front of the network device.

11. The network device of claim 1, wherein the second coverage area corresponds to at least one of an area below the network device or an area behind the network device.

12. The network device of claim 1, wherein an auxiliary connector of the one or more auxiliary connectors allows at least one external antenna of the set of external antennas to be rotatably coupled thereto.

13. The network device of claim 1, wherein an auxiliary connector of the one or more auxiliary connectors allows at least one external antenna of the set of external antennas to be rotatably coupled thereto via a mating connector.

14. A communication system, comprising:
a network device comprising:
a set of integral antennas configured to generate at least one beam pattern defining a first coverage area from a first end of the network device; and
one or more auxiliary connectors extending from a second end of the network device; and
a set of external antennas couplable to the one or more auxiliary connectors to generate one or more beam patterns defining a second coverage area disparate from the first coverage area.

15. The communication system of claim 14, wherein at least one external antenna of the set of external antennas is rotatably couplable to an auxiliary connector of the one or more auxiliary connectors via a mating connector.

16. The communication system of claim 15, wherein the at least one external antenna is tiltable via a hinged connection to the mating connector.

17. The communication system of claim 14, wherein at least one external antenna of the set of external antennas is couplable to an auxiliary connector of the one or more auxiliary connectors via a coaxial interconnect element.

18. The communication system of claim 14, wherein at least one external antenna of the set of external antennas is a direct-mount antenna.

19. The communication system of claim 14, wherein the first coverage area corresponds to an area in front of the network device and the second coverage area corresponds to at least one of an area below the network device or an area behind the network device.

20. A method comprising:
configuring a set of integral antennas to generate at least one beam pattern defining a first coverage area from a first end of a network device;
detecting a coupling of an external antenna to an auxiliary connector of one or more auxiliary connectors extending from a second end of the network device; and
selectively re-routing a radio frequency signal path from the set of integral antennas to the external antenna via the auxiliary connector to generate one or more beam patterns defining a second coverage area disparate from the first coverage area.
